(19) United States
(12) Patent Application Publication
(10) Pub. No.: US 2026/0041246 A1
(43) Pub. Date: Feb. 12, 2026

(54) FOOTREST APPARATUS

(71) Applicant: TOYODA GOSEI CO., LTD., Kiyosu-shi (JP)

(72) Inventors: Haruka JIN, Kiyosu-shi (JP); Nobuhiro TERAI, Kiyosu-shi (JP); Toshihiko KAJIYAMA, Kiyosu-shi (JP)

(21) Appl. No.: 19/286,395

(22) Filed: Jul. 31, 2025

(30) Foreign Application Priority Data
Aug. 9, 2024 (JP) 2024-134522

(51) Int. Cl. A47C 16/02; H05B 3/36

(52) U.S. Cl. CPC A47C 16/025; H05B 3/36

(57) ABSTRACT

To downsize a footrest apparatus, the footrest apparatus includes: a base portion forming a footstool for a person to rest feet thereon; and a leg portion attached on a bottom surface side of the base portion and being pivotable about a shaft extending in a direction along a bottom surface of the base portion, between a folded state in which the leg portion extends along the bottom surface of the base portion, from one end on the shaft side to another end on a distal end side, and an unfolded state in which the leg portion extends so as to protrude outward from the bottom surface of the base portion, from the one end on the shaft side to the other end on the distal end side. The leg portion is provided so as to be accommodated between both ends of the base portion in a direction along the shaft.

### TECHNICAL FIELD

The present disclosure relates to a footrest apparatus used as a footstool apparatus on which the feet of a person are rested.

### BACKGROUND ART

Conventionally, there has been known a footrest apparatus for supporting the feet of a vehicle occupant (for example, Japanese Examined Utility Model Publication No. H06-8920; hereinafter, Patent Literature 1). The footrest apparatus described in Patent Literature 1 includes a base portion forming a footstool, and a leg portion pivotable relative to the base portion. The base portion is formed in a case shape. The leg portion is pivotable about a shaft extending in a direction along the bottom surface of the base portion and is formed to extend in an arm shape from one end on the shaft side to the other end on the distal end side.

The leg portion is pivotable between a folded state in which the leg portion extends along the bottom surface of the base portion, from one end on the shaft side to the other end on the distal end side, and an unfolded state in which the leg portion extends so as to protrude outward from the bottom surface of the base portion, from the one end on the shaft side to the other end on the distal end side. When the footrest apparatus is placed on a floor in front of a vehicle seat, in the folded state of the leg portion, the footstool of the base portion faces substantially in a vertically upward direction, and in the unfolded state of the leg portion, the footstool is inclined obliquely upward to the vehicle seat side relative to the floor so as to readily support the feet of a vehicle occupant.

### SUMMARY OF INVENTION

### Technical Problem

However, in the footrest apparatus described in Patent Literature 1, both ends of the leg portion at a part where the shaft is provided protrude outward of the shaft relative to both ends of side walls of the base portion. Specifically, when the leg portion is in the folded state relative to the base portion, parts of the leg portion cover the side walls at both ends in the shaft direction of the base portion from the shaft-direction outer sides. Therefore, there is a limitation in reducing the shaft-direction length between both ends of the leg portion, and the size of the footrest apparatus is increased for allowing the leg portion to pivot between the folded state and the unfolded state relative to the base portion.

The present disclosure has been made in view of the above circumstances, and an object of the present disclosure is to provide a footrest apparatus having a reduced size.

### Solution to Problem

The present disclosure discloses a footrest apparatus including: a base portion forming a footstool configured to allow a person to rest feet thereon; and a leg portion attached on a bottom surface side of the base portion, the leg portion being pivotable about a shaft extending in a direction along a bottom surface of the base portion, between a folded state in which the leg portion extends along the bottom surface of the base portion, from one end on the shaft side to another end on a distal end side, and an unfolded state in which the leg portion extends so as to protrude outward from the bottom surface of the base portion, from the one end to the other end. The leg portion is provided so as to be accommodated between both ends of the base portion in a direction along the shaft.

According to the present disclosure, the size of the footrest apparatus is reduced.

### BRIEF DESCRIPTION OF DRAWINGS

FIG. 1 is a perspective view of a footrest apparatus according to one embodiment as seen from the top surface side in an unfolded state of a leg portion.

FIG. 2 is a side view of the footrest apparatus of the embodiment as seen in the unfolded state of the leg portion.

FIG. 3 is an exploded view of the footrest apparatus of the embodiment.

FIG. 4 is a sectional view of a base portion included in the footrest apparatus of the embodiment.

FIG. 5 is a top view of a heater included in the footrest apparatus of the embodiment.

FIG. 6 is a perspective view of the footrest apparatus of the embodiment as seen from the bottom surface side in the folded state of the leg portion.

FIG. 7 is a perspective view of the footrest apparatus of the embodiment as seen from the bottom surface side in the unfolded state of the leg portion.

FIG. 8 is a back view of the footrest apparatus of the embodiment as seen from the bottom surface side in the unfolded state of the leg portion.

FIG. 9 is a sectional view of a hinge part in the folded state in the footrest apparatus of the embodiment.

FIG. 10 is a sectional view of the hinge part in the unfolded state in the footrest apparatus of the embodiment.

### DESCRIPTION OF EMBODIMENTS

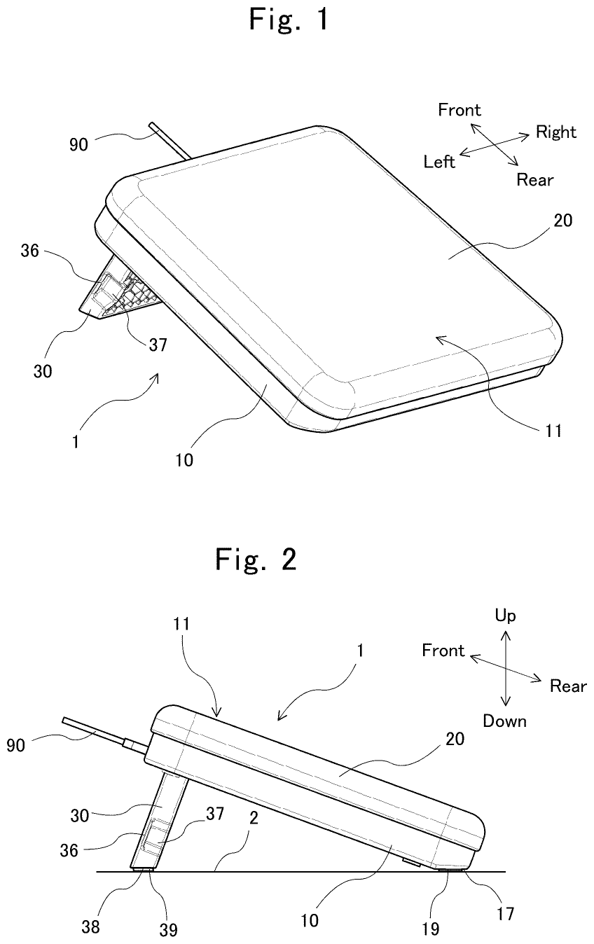

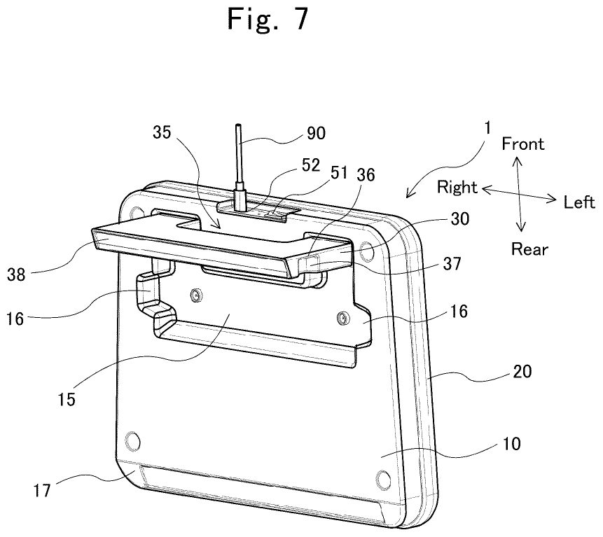

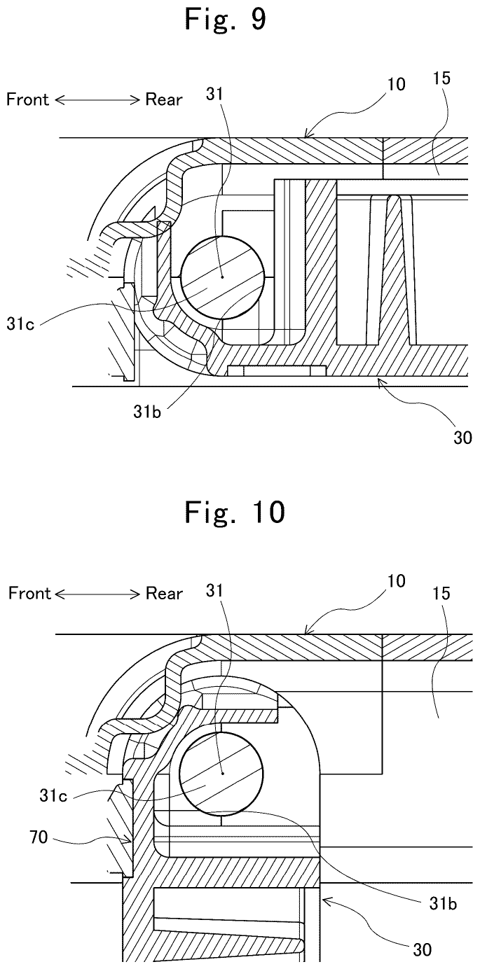

Hereinafter, with reference to FIG. 1 to FIG. 10, specific embodiments of a footrest apparatus according to the present invention will be described.

A footrest apparatus 1 according to one embodiment is a structure on which a person sitting on a seat or the like rests the feet, and is an apparatus for supporting the feet of the person. The footrest apparatus 1 is portable so as to be carriable. The footrest apparatus 1 is placed on a floor (hereinafter, referred to as a placement floor 2; see FIG. 2) in front of a vehicle seat, for example, and supports the feet of a vehicle occupant sitting on the vehicle seat.

In the following description, directions such as a “frontward direction” and a “rearward direction” are based on the front direction in which a person resting the feet on the footrest apparatus 1 faces. For example, the “frontward direction” is a direction in which a person resting the feet on the footrest apparatus 1 extends the feet, and a “left-right direction” is a left-right direction based on a person resting the feet on the footrest apparatus 1.

As shown in FIG. 1 to FIG. 10, the footrest apparatus 1 includes a base portion 10, a skin portion 20, a leg portion 30, a heater 40, a control unit 50, a folding lock mechanism 60, and an unfolding lock mechanism 70.

The base portion 10 is a member forming a body of the footrest apparatus 1. The base portion 10 forms a footstool 11 configured to allow a person to rest the feet thereon. The base portion 10 is formed in a plate shape that is rectangular or trapezoidal in a plan view and has a predetermined thickness, for example. The base portion 10 has a size that allows a person to rest the two feet thereon in an aligned state, and has a structure and a thickness that ensure rigidity against a load when the two feet are rested. As long as the base portion 10 is configured to support the person's feet rested thereon, the surface of the base portion 10 may be formed in a flat plate shape or a mesh shape. The base portion 10 may be intended to allow a person to rest thereon the feet wearing shoes, or may be intended to allow a person to rest thereon the feet with shoes off.

The base portion 10 is composed of an inner base member 12 and an outer base member 13. The inner base member 12 is a case member placed on the bottom surface side of the base portion 10. The outer base member 13 is a lid member placed on the top surface side of the base portion 10 and covering the opening of the inner base member 12. The inner base member 12 and the outer base member 13 are overlaid on each other in the thickness direction (i.e., top-bottom direction) of the base portion 10 and attached to each other by snap-fit or the like. Each of the inner base member 12 and the outer base member 13 is formed by a resin material, for example.

Preferably, the inner base member 12 has a rib structure therein for ensuring rigidity. The outer base member 13 has a depressed portion 13a. The depressed portion 13a is a portion where a part of the skin portion 20 and the heater 40 are stored. The depressed portion 13a is formed to be recessed to the bottom surface side from the top surface of the outer base member 13.

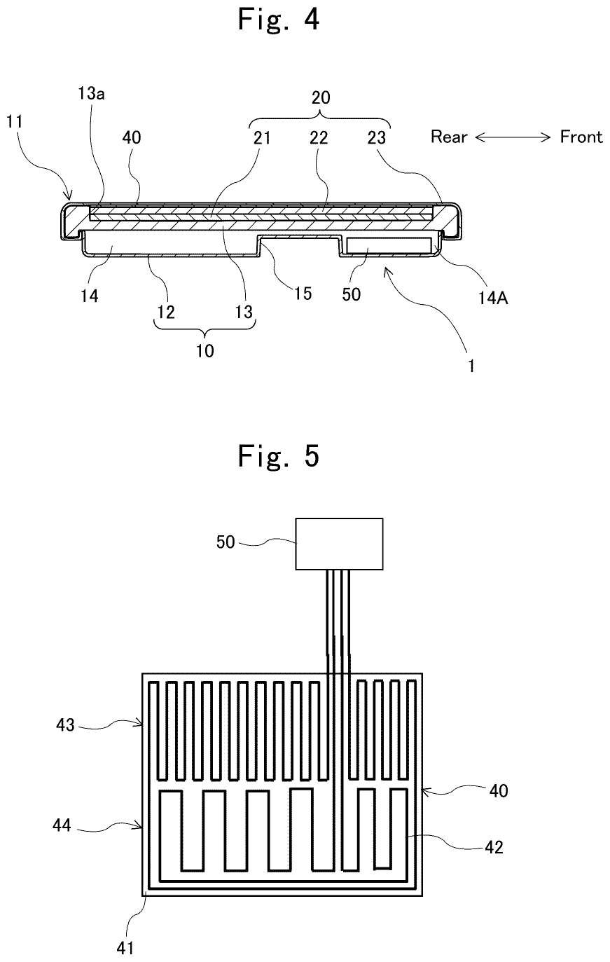

The base portion 10 has therein a closed internal space 14 (see FIG. 4) formed by the inner base member 12 and the outer base member 13 attached to each other. That is, the internal space 14 is formed between the inner base member 12 and the outer base member 13. The base portion 10 is formed in a housing shape having the internal space 14. The control unit 50 described later in detail is stored in the internal space 14.

The skin portion 20 is a member covering the top surface side of the base portion 10 (specifically, the outer base member 13). The skin portion 20 is composed of a urethane material 21, a cushion material 22, and a skin 23. In the skin portion 20, the urethane material 21, the cushion material 22, and the skin 23 are arranged in this order from the bottom surface side.

The urethane material 21 is a hard resin or a soft resin having a heat insulating property and a shock absorbing property. The urethane material 21 is formed so as to contact with the top surface of the outer base member 13 of the base portion 10 and cover the entire top surface of the outer base member 13. The cushion material 22 is a member that ensures a cushion property when a person rests the feet thereon. The cushion material 22 is provided on the top surface of the urethane material 21. The urethane material 21 and the cushion material 22 are stored in the depressed portion 13a of the outer base member 13. The skin 23 is a skin member exposed at the top surface of the footrest apparatus 1. The skin 23 covers outer surfaces of the urethane material 21 and the cushion material 22 overall and covers an outer surface of the outer base member 13 (specifically, an outer surface of a frame part appearing on the outer side of the depressed portion 13a, of the outer base member 13).

The leg portion 30 is a member for inclining the top surface of the footstool 11, i.e., the base portion 10, relative to the placement floor 2 when the footrest apparatus 1 is placed on the placement floor 2. The leg portion 30 is attached to the bottom surface side of the base portion 10. The leg portion 30 is changeable in posture relative to the base portion 10. Specifically, the leg portion 30 is pivotable between the folded state and the unfolded state about a shaft 31. The leg portion 30 pivots between the folded state and the unfolded state through an operation by a person who is an operator.

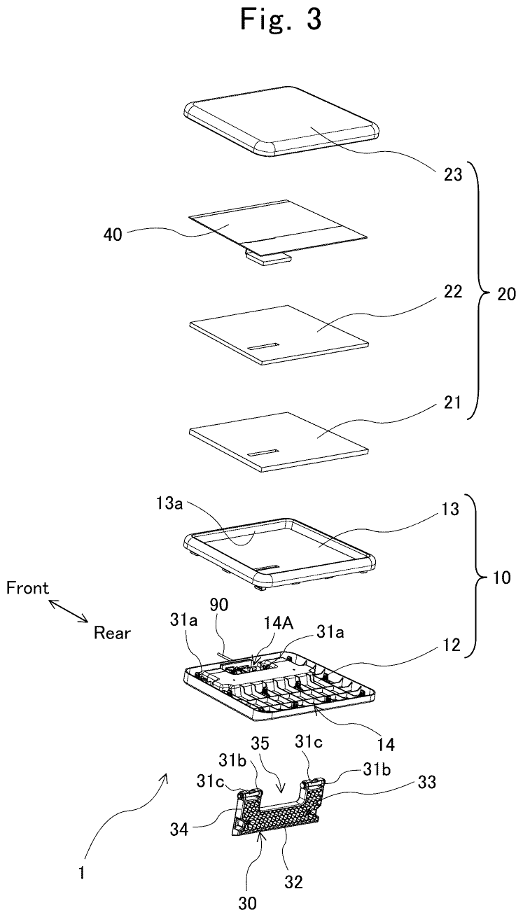

The shaft 31 extends in a direction (specifically, the left-right direction) along the bottom surface of the base portion 10. The shaft 31 forms a hinge composed of an axial hole 31a formed in the base portion 10, an axial hole 31b formed in the leg portion 30, and an axial pin 31c (see FIG. 3).

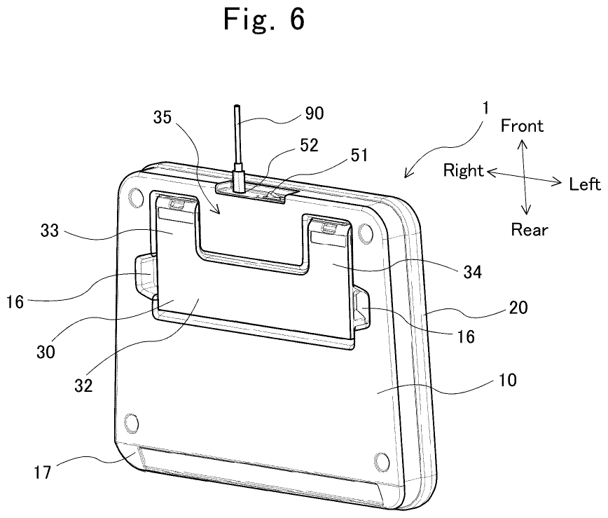

The leg portion 30 is formed in a plate shape spreading along the extending direction of the shaft 31 while extending in the longitudinal direction from one end on the shaft 31 side toward the other end on the distal end side. The leg portion 30 is formed in a forked shape so as to have a rectangular leg body portion 32, and a first shaft support portion 33 and a second shaft support portion 34 each extending in the longitudinal direction from the leg body portion 32, as shown in FIG. 3 and FIG. 6, for example. The leg portion 30 has a honeycomb structure, a grating structure, a rib structure, or the like so as to ensure rigidity against a load when the feet of a person are rested on the footstool 11.

The first shaft support portion 33 and the second shaft support portion 34 are provided so as to be separated from each other in the left-right direction in which the shaft 31 extends. A gap 35 is formed between the first shaft support portion 33 and the second shaft support portion 34. Each of the first shaft support portion 33 and the second shaft support portion 34 has a part through which the shaft 31 penetrates, on the distal end side separated in the longitudinal direction from the leg body portion 32. The first shaft support portion 33 and the second shaft support portion 34 pivot about the shaft 31 integrally with the leg body portion 32.

The leg portion 30 is at least formed to extend in the longitudinal direction from one end on the shaft 31 side to the other end on the distal end side, and may be composed of a plurality of bar-shaped bodies divided in the left-right direction in which the shaft 31 extends. In addition, the leg portion 30 is at least formed to be a pivoting body pivotable about one shaft 31, and may be composed of a plurality of pivoting bodies pivotable respectively about a plurality of shafts 31 arranged in parallel to each other, for example.

The aforementioned folded state is a state in which the leg portion 30 extends along the bottom surface of the base portion 10, from one end on the shaft 31 side to the other end on the distal end side. The aforementioned unfolded state is a state in which the leg portion 30 extends so as to protrude outward from the bottom surface of the base portion 10, from one end on the shaft 31 side to the other end on the distal end side. That is, in the folded state, particularly the distal end side of the leg portion 30 is close to the base portion 10, but in the unfolded state, the distal end side protrudes outward away from the base portion 10. When the footrest apparatus 1 is placed on the placement floor 2 in the unfolded state of the leg portion 30, the other end on the distal end side of the leg portion 30 and a part of the base portion 10 contact with the placement floor 2.

An angle of the leg portion 30 relative to the bottom surface of the base portion 10 in the unfolded state may be limited to only one value and may be a fixed value of approximately 90°. In the unfolded state of the leg portion 30, when the footrest apparatus 1 is placed on the placement floor 2, the footstool 11 of the base portion 10 is inclined relative to the placement floor 2. An angle of the footstool 11 relative to the placement floor 2 may be an optimum angle that does not give a feeling of fatigue to a person even when the person rests the feet on the footstool 11 for a long time, for example. This angle may be in a range of 15°to 30°, for example, and is preferably a fixed value of approximately 20°. A length from one end to another end of the leg portion 30 may be set so that the angle of the footstool 11 relative to the placement floor 2 in the unfolded state of the leg portion 30 becomes the above fixed value.

The leg portion 30 is provided so as to be accommodated between both ends of the base portion 10 in the left-right direction along the shaft 31. Specifically, in the folded state of the leg portion 30, both ends in the left-right direction at each part in the longitudinal direction of the leg portion 30 are located on the inner side in the left-right direction relative to both ends in the left-right direction of the base portion 10. The distance between both ends in the left-right direction along the shaft 31 of the leg portion 30 is smaller than the distance between both ends in the left-right direction along the shaft 31 of the base portion 10 at a part where the leg portion 30 is provided. Specifically, in the folded state of the leg portion 30, the distance between both ends in the left-right direction at each part in the longitudinal direction of the leg portion 30 is smaller than the distance between both ends in the left-right direction of the base portion 10 at the longitudinal-direction position of the part of the leg portion 30.

The leg portion 30 is provided so as to be accommodated between both ends of the base portion 10 in the left-right direction along the shaft 31, at least in the folded state. That is, in a case where the outer shape of the leg portion 30 is, for example, a trapezoidal shape instead of a rectangular shape, the leg portion 30 may be formed so that a part thereof is located on the outer side relative to either end in the left-right direction of the base portion 10, in the unfolded state.

The base portion 10 has a storage recess 15. The storage recess 15 is a part where the leg portion 30 in the folded state is stored. The storage recess 15 is provided on the bottom surface side of the base portion 10. The storage recess 15 may be provided on the front side on the bottom surface side of the base portion 10. The storage recess 15 is formed to be recessed to the top surface side from the bottom surface of the base portion 10. In the folded state of the leg portion 30, the storage recess 15 stores the leg portion 30, and in the unfolded state of the leg portion 30, the storage recess 15 is exposed at the bottom surface of the base portion 10. The storage recess 15 has a shape matching the shape of the leg portion 30 and is formed so that the entire leg portion 30 does not protrude from the bottom surface of the base portion 10. The storage recess 15 stores the leg portion 30 in the folded state such that the leg body portion 32 is located rearward and the first shaft support portion 33 and the second shaft support portion 34 are located frontward.

The base portion 10 has an operation recess 16. The operation recess 16 is a part that allows a finger of an operator to be inserted therein for pivoting the leg portion 30 from the folded state to the unfolded state. The operation recess 16 is integrated with the storage recess 15. That is, the operation recess 16 is provided contiguously to the storage recess 15, and is formed to be recessed to the top surface side from the bottom surface of the base portion 10. The operation recess 16 is exposed at the bottom surface of the base portion 10, both when the leg portion 30 is stored in the storage recess 15 and is in the folded state and when the leg portion 30 is separated from the storage recess 15 and is in the unfolded state. Preferably, the operation recess 16 is contiguous to a part that is separated as much as possible radially outward of the shaft 31 (i.e., rearward) from a part where the shaft 31 is provided in the storage recess 15. The operation recess 16 is provided at one or more locations, and may be provided one by one on the left and right sides of the storage recess 15, for example.

The leg portion 30 has an operation portion 36. The operation portion 36 is a part to be caught by a finger of an operator inserted in the operation recess 16 of the base portion 10, in the folded state of the leg portion 30. The leg portion 30 has a cutout 37 provided at a side wall on the left side and/or the right side of the leg portion 30, and the cutout 37 is contiguous to the operation recess 16 in the folded state of the leg portion 30. The operation portion 36 is pulled by being caught by a finger of an operator inserted in the operation recess 16 of the base portion 10 and entering the cutout 37, in the folded state of the leg portion 30, and a force for pivoting the leg portion 30 from the folded state to the unfolded state is given by the finger.

The leg portion 30 has a contact surface 38. The contact surface 38 is a part to surface-contact with the placement floor 2 in the unfolded state of the leg portion 30. The contact surface 38 is provided for stabilizing the posture of the footstool 11 in the unfolded state of the leg portion 30. The contact surface 38 is formed in a planar shape at an end surface on the distal end side opposite to one end on the shaft 31 side, of the leg portion 30. On the contact surface 38, a contact member 39 formed by a protection member such as a protection sheet or a film tape for preventing damage or a slip-resistance member for preventing slip is preferably pasted.

The contact surface 38 is inclined relative to a direction perpendicular to a direction extending between one end and the other end of the leg portion 30, in accordance with an angle of the direction extending between the one end and the other end relative to the vertical direction in the unfolded state of the leg portion 30. That is, when the angle of the direction extending between the one end and the other end in the unfolded state of the leg portion 30 relative to the vertical direction is zero, the contact surface 38 spreads in the direction perpendicular to the direction extending between the one end and the other end of the leg portion 30, and when the angle of the direction extending between the one end and the other end in the unfolded state of the leg portion 30 relative to the vertical direction is, for example, 22°, the contact surface 38 is inclined by 22°relative to the direction perpendicular to the direction extending between the one end and the other end of the leg portion 30.

The base portion 10 has an inclined surface 17. The inclined surface 17 is a part to surface-contact (specifically, planarly contact) with the placement floor 2 in the unfolded state of the leg portion 30. The inclined surface 17 is provided for stabilizing the posture of the footstool 11 in the unfolded state of the leg portion 30. The inclined surface 17 is located rearward of a part where the leg portion 30 is provided in the base portion 10, and is formed in a planar shape spreading in the left-right direction along the shaft 31 at a connection part between the bottom surface and a rear end surface of the base portion 10. The inclined surface 17 is inclined relative to the bottom surface of the base portion 10 and inclined relative to the rear end surface of the base portion 10. The inclined surface 17 is inclined relative to the bottom surface of the base portion 10, at the same angle as the angle of the footstool 11 relative to the placement floor 2 in the unfolded state of the leg portion 30. On the inclined surface 17, a contact member 19 formed by a protection member such as a protection sheet or a film tape for preventing damage or a slip-resistance member for preventing slip is preferably pasted.

The heater 40 is a heat generating member for warming person's feet rested on the footstool 11. The heater 40 is provided in the skin portion 20. Specifically, the heater 40 is provided between the cushion material 22 and the skin 23, as shown in FIG. 4. The heater 40 may be provided between the urethane material 21 and the cushion material 22. The heater 40 heats the skin portion 20, to warm person's feet rested on the footstool 11.

As shown in FIG. 5, the heater 40 has a heat generating body 42 retained at an insulation sheet 41. The insulation sheet 41 at which the heat generating body 42 is retained is retained by being held between the cushion material 22 and the skin 23. The heat generating body 42 is formed by a heating wire, and is activated by being supplied with power from an external battery, thus generating heat. When the heat generating body 42 of the heater 40 generates heat, the surface temperature of the footstool 11 becomes a predetermined temperature. The predetermined temperature is preferably set to a temperature at which a person feels warm on the soles of the feet even in winter, e.g., 33° C. or higher, which is experimentally obtained.

As shown in FIG. 5, the heater 40 may have a first area 43 and a second area 44 where the density of the heat generating body 42 is different therebetween. The first area 43 is an area where the heat generating body 42 is densely provided. The second area 44 is an area where the heat generating body 42 is sparsely provided. The first area 43 is located on the front side of the footrest apparatus 1, and the second area 44 is located on the rear side of the footrest apparatus 1. In this structure, when power is supplied to the heat generating body 42, the first area 43 is more readily heated than the second area 44, so that, when the feet of a person are rested on the footstool 11, particularly the toes are readily warmed.

The control unit 50 is an electronic device which controls heating of the heater 40. The control unit 50 is electrically connected to the heat generating body 42 of the heater 40. The control unit 50 turns on activation of the heat generating body 42 by turning on a heater switch 51 provided therefor, and turns off activation of the heat generating body 42 by turning off the heater switch 51. Activation of the heater 40 may be automatically turned on or off along with, for example, an air conditioner operation in a vehicle provided with the footrest apparatus 1. Activation of the heater 40 may be automatically turned on when a temperature sensor detects that the outside temperature is equal to or lower than a predetermined temperature, and may be automatically turned off when the temperature sensor detects that the outside temperature is higher than the predetermined temperature.

The control unit 50 is stored in the internal space 14 of the base portion 10. In the base portion 10, the internal space 14 is provided so as to include a corresponding part 14A corresponding to the gap 35 between the first shaft support portion 33 and the second shaft support portion 34 in the folded state of the leg portion 30. The control unit 50 is stored in the corresponding part 14A in the internal space 14.

The control unit 50 is connected to the heater switch 51 and connected to a connector 52. The heater switch 51 is a switch for turning on/off activation of the heat generating body 42. The connector 52 is a connection part for supplying power to the heat generating body 42. The heater switch 51 and the connector 52 are provided at a front end surface of the base portion 10. An end of a cable 90 such as a USB cable is connectable to the connector 52. The cable 90 is attachable to and detachable from the connector 52, and connects an external battery and the connector 52 to supply power from the external battery to the heat generating body 42 via the control unit 50.

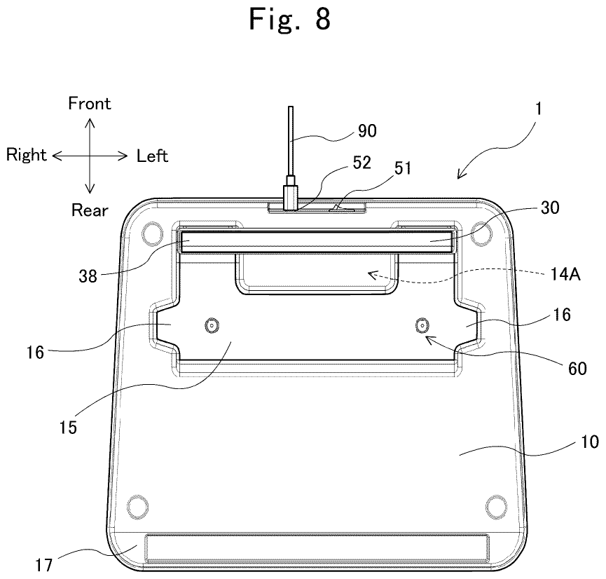

The folding lock mechanism 60 is a mechanism for locking the leg portion 30 in the folded state. When the leg portion 30 is in the folded state, the folding lock mechanism 60 fixes the base portion 10 and the leg portion 30 by snap-fit or a magnetic force of a magnet, thereby restricting the leg portion 30 from moving from the folded state to the unfolded state. The folding lock mechanism 60 is provided at a part around the shaft 31 in the base portion 10 and the leg portion 30, and a part where the base portion 10 and the leg portion 30 are opposed to each other in the folded state of the leg portion 30 as shown in FIG. 8. Lock in the folded state of the leg portion 30 by the folding lock mechanism 60 is released by an operator pulling the operation portion 36.

The unfolding lock mechanism 70 is a mechanism for locking the leg portion 30 in the unfolded state. When the leg portion 30 is in the unfolded state, the unfolding lock mechanism 70 fixes the base portion 10 and the leg portion 30 by snap-fit or a magnetic force of a magnet, thereby restricting the leg portion 30 from moving from the unfolded state to the folded state. The unfolding lock mechanism 70 is provided at a part around the shaft 31 in the base portion 10 and the leg portion 30 as shown in FIG. 10. Lock in the unfolded state of the leg portion 30 by the unfolding lock mechanism 70 is released by an operator pressing the leg portion 30 in the unfolded state to the storage recess 15 side.

Next, operation of the footrest apparatus 1 will be described.

In the footrest apparatus 1, when the footstool 11 is not used, the leg portion 30 is stored in the storage recess 15 of the base portion 10 and locked in the folded state by the folding lock mechanism 60. In this state, the leg portion 30 does not protrude outward from the bottom surface of the base portion 10, and therefore portability when a person carries the footrest apparatus 1 improves.

In the footrest apparatus 1, when the footstool 11 is used from a state in which the leg portion 30 is locked in the folded state, first, an operator inserts a finger into the operation recess 16 of the base portion 10 and moves the finger into the cutout 37 of the leg portion 30 so that the finger is caught on the operation portion 36. In this state, when the operator pulls the operation portion 36 outward, lock in the folded state of the leg portion 30 is released, and the leg portion 30 pivots toward the unfolded state relative to the base portion 10. Then, when the leg portion 30 reaches the unfolded state, the leg portion 30 is locked in the unfolded state by the unfolding lock mechanism 70. In this state, the leg portion 30 protrudes outward from the bottom surface of the base portion 10, and the footrest apparatus 1 is placed on the placement floor 2, so as to be used as the footstool 11.

When the footrest apparatus 1 is placed on the placement floor 2 in front of the seat in the unfolded state of the leg portion 30, a person sitting on the seat is allowed to rest the feet on the footstool 11 inclined relative to the placement floor 2. Thus, in the footrest apparatus 1, the leg portion 30 is inclined relative to the placement floor 2 obliquely upward to the seat side, in the unfolded state of the leg portion 30, whereby the feet of a person sitting on the seat is readily supported.

When the heater 40 of the footrest apparatus 1 is used, first, one end of the cable 90 is connected to the connector 52 of the base portion 10, whereby power is supplied from an external battery to the control unit 50 and the heat generating body 42. Then, when the heater switch 51 is turned on, power from the external battery is supplied to the heat generating body 42 via the control unit 50. When power is supplied to the heat generating body 42, the heat generating body 42 generates heat, to heat the skin portion 20. Thus, particularly in winter or the like, person's feet rested on the footstool 11 are warmed.

Next, effects of the footrest apparatus 1 will be described. In the footrest apparatus 1, the leg portion 30 is provided so as to be accommodated between both ends of the base portion 10 in the left-right direction along the shaft 31. With this structure, the leg portion 30 is prevented from protruding outward in the left-right direction relative to both ends in the left-right direction of the base portion 10. Therefore, even if the size (in particular, the distance between both ends in the left-right direction) of the base portion 10 is large, the left-right direction distance between both ends in the left-right direction of the leg portion 30 is shortened irrespective of the size, whereby the footrest apparatus 1 is reduced in size while allowing the leg portion 30 to pivot between the folded state and the unfolded state relative to the base portion 10.

In the footrest apparatus 1, the left-right direction distance between both ends in the left-right direction along the shaft 31 of the leg portion 30 is smaller than the left-right direction distance between both ends in the left-right direction along the shaft 31 of the base portion 10 at a part where the leg portion 30 is provided. Also with this structure, the footrest apparatus 1 is reduced in size while allowing the leg portion 30 to pivot between the folded state and the unfolded state relative to the base portion 10.

When the footrest apparatus 1 is placed on the placement floor 2 in the unfolded state of the leg portion 30, the contact surface 38 which is an end surface on the distal end side of the leg portion 30, and the inclined surface 17 formed in a planar shape at the connection part between the bottom surface and the rear end surface of the base portion 10, contact with the placement floor 2. In this structure, a floor contact part contacting with the placement floor 2, of the footrest apparatus 1, is prevented from ranging over the entire bottom surface of the base portion 10, and the floor contact part is limited to a narrow range. Thus, the hands of a person are less likely to touch the floor contact part of the footrest apparatus 1 which is carriable by a person, and the hands of a person are prevented from being stained when the footrest apparatus 1 is carried.

The contact surface 38 of the leg portion 30 surface-contacts with the placement floor 2 in the unfolded state. With this structure, the area where the leg portion 30 contacts with the placement floor 2 in the unfolded state of the leg portion 30 is ensured, whereby posture stability of the footrest apparatus 1 in the unfolded state of the leg portion 30 is improved. The contact surface 38 is inclined relative to the direction perpendicular to the direction extending between one end and the other end of the leg portion 30, in accordance with the angle of the direction extending between the one end and the other end in the unfolded state of the leg portion 30 relative to the vertical direction. Thus, the part where the contact surface 38 contacts with the placement floor 2 has a planar shape.

The inclined surface 17 of the base portion 10 surface-contacts with the placement floor 2 in the unfolded state of the leg portion 30. With this structure, even if the footstool 11 is inclined relative to the placement floor 2 in the unfolded state of the leg portion 30, the area where the base portion 10 contacts with the placement floor 2 is ensured, whereby posture stability of the footrest apparatus 1 in the unfolded state of the leg portion 30 is improved.

In the footrest apparatus 1, the base portion 10 has, on the bottom surface side, the storage recess 15 which stores the leg portion 30 in the folded state. In this structure, the leg portion 30 is stored in the storage recess 15 of the base portion 10, in the folded state. Therefore, in the folded state of the leg portion 30, the leg portion 30 is prevented from protruding outward from the bottom surface of the base portion 10. Thus, the outer shape of the footrest apparatus 1 when the leg portion 30 is in the folded state is prevented from becoming an irregular shape different from a rectangular shape, whereby the footrest apparatus 1 with the leg portion 30 in the folded state is stored in a more stable state.

The base portion 10 has the operation recess 16 contiguous to the storage recess 15 and configured to allow a finger of an operator to be inserted therein for pivoting the leg portion 30 from the folded state to the unfolded state. In this structure, when the operator pivots the leg portion 30 from the folded state to the unfolded state by the finger, the pivoting operation is easily performed and the pivoting operability is improved.

The leg portion 30 has the operation portion 36 to be caught by the finger of the operator inserted in the operation recess in the folded state. In this structure, the operator catches the operation portion 36 by the finger when pivoting the leg portion 30 from the folded state to the unfolded state. Thus, the pivoting operation is assisted and the pivoting operability is improved.

The footrest apparatus 1 includes the folding lock mechanism 60 configured to lock the leg portion 30 in the folded state. In this structure, when the leg portion 30 is in the folded state, the folded state is retained, whereby the leg portion 30 in the folded state is prevented from readily moving toward the unfolded state side.

The footrest apparatus 1 includes the unfolding lock mechanism 70 configured to lock the leg portion 30 in the unfolded state. In this structure, when the leg portion 30 is in the unfolded state, the unfolded state is retained, whereby the leg portion 30 in the unfolded state is prevented from readily moving toward the folded state side.

The footrest apparatus 1 includes the heater 40 configured to heat the skin portion 20 and provided in the skin portion 20 covering the top surface side of the base portion 10. With this structure, the skin portion 20 is heated using the heater 40, whereby person's feet rested on the footstool 11 are warmed through heat transfer.

The heater 40 is heat-controlled by the control unit 50 electrically connected to the heater 40. The control unit 50 is stored in the internal space 14 formed between the inner base member 12 and the outer base member 13 of the base portion 10. With this structure, the internal space 14 formed between the inner base member 12 and the outer base member 13 composing the base portion 10 of the footrest apparatus 1 is used as a storage space for storing the control unit 50. Thus, a space formed in the thickness direction of the footrest apparatus 1 is efficiently utilized.

As in the present embodiment, in the structure in which the leg portion 30 is formed in a forked shape and has the first shaft support portion 33 and the second shaft support portion 34 each extending in the longitudinal direction from the leg body portion 32, the gap 35 is formed between the first shaft support portion 33 and the second shaft support portion 34. The internal space 14 includes the corresponding part 14A corresponding to the gap 35 in the folded state of the leg portion 30. Then, the control unit 50 is stored in the corresponding part 14A in the internal space 14. With this structure, the corresponding part 14A corresponding to the gap 35 in the folded state of the leg portion 30, of the internal space 14, is used as a storage space for storing the control unit 50, and thus a space formed in the thickness direction of the footrest apparatus 1 is efficiently utilized.

In the above embodiment, when the footrest apparatus 1 is placed on the placement floor 2 in the unfolded state of the leg portion 30, parts where the footrest apparatus 1 contacts with the placement floor 2 are the contact surface 38 of the leg portion 30 and the inclined surface 17 of the base portion 10. However, the present disclosure is not limited thereto. The base portion 10 may have a fixed leg portion for stabilizing the angle of the footstool 11 relative to the placement floor 2 in the unfolded state of the leg portion 30, and parts where the footrest apparatus 1 contacts with the placement floor 2 in the unfolded state of the leg portion 30 may include the fixed leg portion of the leg portion 30, in addition to the contact surface 38 of the leg portion 30 and the inclined surface 17 of the base portion 10.

The fixed leg portion may be formed in a protrusion shape protruding outward from the bottom surface of the base portion 10 so that a protrusion distal end contacts with the placement floor 2 in the unfolded state of the leg portion 30. The fixed leg portion may be provided at a part close to the inclined surface 17 which contacts with the placement floor 2 in the unfolded state of the leg portion 30, of the bottom surface of the base portion 10. For example, a pair of fixed leg portions may be provided near ends in the left-right direction on the bottom surface of the base portion 10.

In the above embodiment, the angle of the leg portion 30 relative to the bottom surface of the base portion 10 in the unfolded state of the leg portion 30 is limited to only one angle. However, the present disclosure is not limited thereto. The angle may be adjustable in two or more levels, and the footrest apparatus 1 may include an angle adjustment mechanism that allows the angle to be adjusted in two or more levels. With the structure of this modification, in the unfolded state of the leg portion 30, the angle of the leg portion 30 relative to the bottom surface of the base portion 10 is adjustable in multiple stages by the angle adjustment mechanism. Thus, the angle of the footstool 11 relative to the placement floor 2 is changeable in accordance with the preference of a person who rests the feet on the footstool 11 of the footrest apparatus 1.

In the above modification, the contact surface 38 of the leg portion 30 which is a part where the footrest apparatus 1 contacts with the placement floor 2 may have a curved shape or a polygonal sectional shape, instead of a planar shape, and a part of the base portion 10 where the footrest apparatus 1 contacts with the placement floor 2 may be a curved surface having a curved shape or a polygonal surface having a polygonal sectional shape, instead of the inclined surface 17 inclined in a planar shape. With this structure, parts where the leg portion 30 and the base portion 10 contact with the placement floor 2 are stably ensured in accordance with the angle of the footstool 11 relative to the placement floor 2, whereby posture stability of the footrest apparatus 1 in the unfolded state of the leg portion 30 is improved.

The present invention is not limited to the embodiments and the modifications described above, and various changes may be made without departing from the gist of the present invention. The description discloses not only technical features shown by the reference relationship described in the claims at the time of filing of the present application but also technical features obtained by combining matters described in the claims as appropriate.

This application claims priority on Japanese Patent Application No. 2024-134522 filed in Japan on Aug. 9, 2024, the entire contents of which are incorporated herein by reference.

1. A footrest apparatus comprising:
a base portion forming a footstool configured to allow a person to rest feet thereon; and
a leg portion attached on a bottom surface side of the base portion, the leg portion being pivotable about a shaft extending in a direction along a bottom surface of the base portion, between a folded state in which the leg portion extends along the bottom surface of the base portion, from one end on the shaft side to another end on a distal end side, and an unfolded state in which the leg portion extends so as to protrude outward from the bottom surface of the base portion, from the one end to the other end, wherein
the leg portion is provided so as to be accommodated between both ends of the base portion in a direction along the shaft.

2. The footrest apparatus according to claim 1, wherein
a distance between both ends in the direction along the shaft of the leg portion is smaller than a distance between both ends in the direction along the shaft of the base portion at a part where the leg portion is provided.

3. The footrest apparatus according to claim 1, wherein
the base portion has, on the bottom surface side, a storage recess which stores the leg portion in the folded state.

4. The footrest apparatus according to claim 3, wherein
the base portion has an operation recess contiguous to the storage recess and configured to allow a finger of an operator to be inserted therein for pivoting the leg portion from the folded state to the unfolded state.

5. The footrest apparatus according to claim 4, wherein
the leg portion has an operation portion to be caught by the finger of the operator inserted in the operation recess in the folded state.

6. The footrest apparatus according to claim 1, wherein
the leg portion has a contact surface formed at an end surface on the other end side and configured to surface-contact with a placement floor in the unfolded state.

7. The footrest apparatus according to claim 1, wherein
the base portion has an inclined surface configured to surface-contact with a placement floor in the unfolded state of the leg portion, or a curved surface formed in a curved shape at a part to contact with the placement floor.

8. The footrest apparatus according to claim 1, wherein
the base portion has a fixed leg portion configured to stabilize an angle of the footstool relative to a placement floor in the unfolded state of the leg portion.

9. The footrest apparatus according to claim 1, further comprising:
a folding lock mechanism configured to lock the leg portion in the folded state; and
an unfolding lock mechanism configured to lock the leg portion in the unfolded state.

10. The footrest apparatus according to claim 1, further comprising:
a skin portion covering a top surface side of the base portion; and
a heater provided in the skin portion and configured to heat the skin portion.

11. The footrest apparatus according to claim 10, further comprising a control unit electrically connected to the heater, wherein
the base portion is formed in a housing shape having an internal space, and
the control unit is stored in the internal space.

12. The footrest apparatus according to claim 11, wherein
the leg portion has a first shaft support portion and a second shaft support portion provided separately from each other in a direction in which the shaft extends, the shaft penetrating through each of the first shaft support portion and the second shaft support portion,
the internal space is provided so as to include a corresponding part corresponding to a gap between the first shaft support portion and the second shaft support portion in the folded state of the leg portion, and
the control unit is stored in the corresponding part in the internal space.
